(19) United States
(12) Patent Application Publication
(10) Pub. No.: US 2022/0055390 A1
(43) Pub. Date: Feb. 24, 2022

(54) SUBLIMATION DEVICES

(71) Applicant: Hewlett-Packard Development Company, L.P., Spring, TX (US)

(72) Inventors: Xavier Oliva Ventayol, Sant Cugat del Valles (ES); Francisco Lopez Moral, Sant Cugat del Valles (ES); Xavier Martinez Puig, Sant Cugat del Valles (ES)

(73) Assignee: Hewlett-Packard Development Company, L.P., Spring, TX (US)

(21) Appl. No.: 17/417,195

(22) PCT Filed: Apr. 25, 2019
(86) PCT No.: PCT/US2019/029226

§ 371 Date: Jun. 22, 2021

(51) Int. Cl. B41M 5/382; B41J 2/32; D06P 5/30; B41M 5/00

(52) U.S. Cl. CPC B41M 5/38221; B41M 5/0052; D06P 5/30; B41J 2/32

(57) ABSTRACT

Examples relate to methods to print a garment and sublimation devices. A sublimation device comprises a heating system to heat an air flow and a holder to receive a garment. The holder comprises an outer surface to contact an inner side of the garment opposite to an outer side of the garment in which a print agent is to be deposited and an opening on the outer surface in fluid communication with the heated air flow.

### BACKGROUND

Sublimation printing processes may be used to print and fix images on a textile material, e.g. a garment fabric. A print agent may be applied to the textile material, sublimated and absorbed by fibers of the textile material to print and fix an image on the textile material.

### BRIEF DESCRIPTION OF THE DRAWINGS

Various example features will be apparent from the detailed description which follows, taken in conjunction with the accompanying drawings, wherein:

FIG. 1a and FIG. 1b respectively illustrates a front view and a side view of an example of a sublimation device according to the present disclosure.

FIG. 2a and FIG. 2b respectively illustrates a holder of the sublimation device of FIG. 1a and FIG. 1b holding a garment.

FIG. 3 illustrates a cross-sectional view of a sublimation device according to one example of the present disclosure.

FIG. 4 schematically illustrates an example of a sublimation device holding a garment according to the present disclosure.

FIG. 5 schematically illustrates an example of a sublimation device holding a garment according to the present disclosure.

FIG. 6 schematically illustrates an example of a system for direct to garment printing according to the present disclosure.

FIG. 7 is a block diagram of an example of a method to print a garment according to the present disclosure.

### DETAILED DESCRIPTION

In textile sector, an image may be directly or indirectly printed on a textile material by using a dye sublimation printing process. Dye sublimation printing (also known in the art as “dye-sub”) is a process to print on textile substrates, e.g. garment fabrics. In an example, the image may be printed onto a textile substrate provided in a roll or sheet format whereas in further examples, the image may be printed directly onto a garment, i.e., direct-to-garment printing.

Moreover, some dye-sub methods may involve printing an image onto a sublimation transfer printable medium, e.g. paper, with a printing system and transferring this image to a final substrate, e.g. to a polyester fabric or to a polymer-coated substrate fabric.

In a sublimation printing process, a print agent, e.g. ink, is converted from a solid to a gaseous state to penetrate into a textile substrate to form an image. At a predetermined temperature, i.e. at or above a sublimation temperature, a print agent is converted to gas which permeates the fibers of the fabric. The gas is again converted to a solid state when the temperature drops and the print agent is thus absorbed and integrated into the fibers. An image is thus printed on a garment fabric, e.g. a polyester garment fabric or to a polymer-coated substrate garment fabric.

Examples of the methods and systems disclosed herein may be used to print a garment avoiding movements during printing and sublimating.

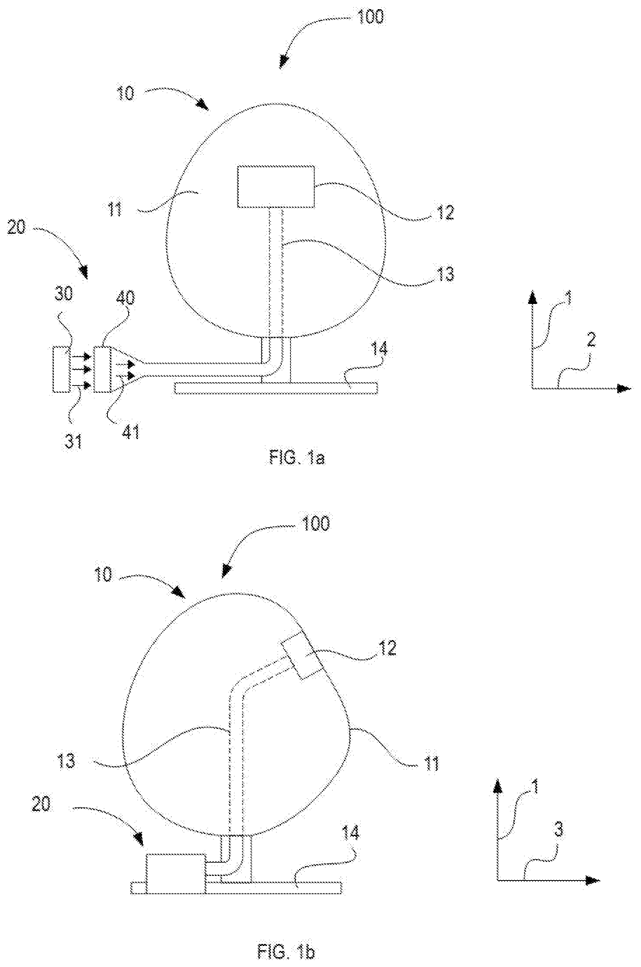

FIG. 1a and FIG. 1b respectively illustrates a front view and a side view of a sublimation device 100 according to an example. The sublimation device 100 comprises a heating system 20 and a holder 10 to receive a garment (not shown in FIG. 1a-1b). The heating system 20 of FIGS. 1a and 1b comprises a flow generator 30 to generate an air flow 31 and a heater 40 to heat the air flow. In this example, the holder 10 comprises an outer surface 11 to contact an inner side of the garment opposite to an outer side of the garment in which a print agent is to be deposited. The holder further comprises an opening 12 on the outer surface 11 in fluid communication with the heated air flow 41.

A print agent may be deposited on an outer side of a garment placed on the holder 10. A heated air flow 41 may be directed through the opening 12 to an inner side of the garment to sublimate the print agent deposited on the outer side. The heated air flow may thus pass through the garment from the inner side to the outer side. A temperature for sublimating a print agent may be achieved by heating the air flow. By directing a heated air flow from inside the holder to the garment a sublimation of a previously deposited print agent is achieved without generating press marks on the garment.

In an example, printing and sublimating may be performed while the garment is received by the holder 10. Movements of the garment during printing and sublimating may thus be avoided. Accordingly, the overall time of sublimation printing (including printing and sublimating) an image on a garment may be reduced. In addition, risks of damaging the print agent deposited on the garment prior to sublimation may be reduced.

In the example of FIGS. 1a, 1b, when using the holder 10 for both, printing and sublimating, the user may not need to move the garment thereby reducing the risk of ghosting effects. Additionally, placing a garment on the holder 10 for depositing a printing agent on it may be facilitated as the garment may be easily centered or aligned because the shape of the holder may correspond to an internal shape defined by an inner side of the garment.

In this disclosure, an outer side of a garment refers to a side of a garment in which a print agent is to be deposited and an inner side refers to the opposite side of the outer side.

The holder of FIGS. 1a and 1b is to receive a garment such that the outer surface 11 contacts an inner side of the garment. The inner side of the garment may thus fit the outer surface of the holder. The garment may thus be placed on the holder such that the garment at least partially covers the holder. In an example, the holder may act as a dress form or a mannequin. The holder may thus have a shape corresponding to an internal shape defined by the inner side of the garment. Accordingly, when the garment is placed on the holder, the outer surface of the holder may provide a pressure to the garment to form a smooth print zone on the outer side to deposit a print agent. Formation of wrinkles on the garment may thus be reduced.

In this disclosure, a garment is a piece of clothing that defines an internal cavity. Examples of garments may be a T-shirt, a pair of trousers or a cap. A piece of textile which can enclose a holder may be an example of a garment according to the disclosure. For example, a flag in which two opposite edges are connected to each other defining a closed piece may also be considered a garment according to this disclosure as an internal cavity is formed. A shirt may also be a garment according to the present disclosure as the shirt may be buttoned up or otherwise provided as to at least partially enclose the holder, so that the holder may receive the shirt. When a holder receives a garment, the internal cavity defined by the garment may be filled by the holder. Accordingly, the holder may be placed inside a garment. The holder may be to be inserted inside a garment.

A garment may be a fabric garment. The garment may comprise fibers permeable to a print agent in gaseous state when a predetermined temperature is applied to allow a print agent to enter in between. In some examples, the fabric garment may be made from a polymer. For example, polyester may be a polymer for a fabric garment.

The holder of FIGS. 1a and 1b has a substantially ovoid shape, in particular, the holder 10 may have an ovoid shape truncated by a flat surface wherein the opening 12 is provided. A shape of the holder may be defined by a length extending along a first axis 1, a width extending along a second axis 2 and a depth extending along a third axis 3. In the example of FIGS. 1a and 1b, the width and the depth of the holder are similar. The holder may have a tridimensional shape similar to a shape of the garment to be received. For example, a holder may have an elongated shape, a cuboid shape, a cylindrical shape or sphere or semi-sphere shape.

In some examples, a holder may have a shape slightly larger than an internal cavity defined by an inner side of a garment. As the garment may be stretchable, the shape of the garment may be adjusted to the outer surface of the holder. Tension provided by the holder onto the garment may thus be increased. Consequently, formation of wrinkles may further be reduced.

In some examples, a holder may be adjustable in shape to fit a shape of the garment to be received. The shape of the holder may vary such that the outer surface of the holder may fit the inner side of the garment. Accordingly, different types of garments, e.g. different sizes of T-shirt, may be printed and sublimated in a single holder. Productivity and adaptability to different types of garments may thus be increased.

The holder may expand or compress to adjust its shape to the garment. In some examples, the holder may be inflatable. In some examples, the outer surface of the garment may be outwardly or inwardly displaced. In some examples, the holder may comprise a tensioner to tense the garment.

The holder of FIGS. 1a and 1b comprises a base 14 for supporting the holder on for example a table. In some examples, the holder may be directly supported on a table. The holder may thus be portable and easily supported in different places and surfaces.

The opening 12 of FIGS. 1a and 1b is in fluid communication with the heated air flow 41 through a conduit 13. The conduit 13 may extend through the holder (illustrated with a dotted line in these figures) to communicate the opening 12 with the heater 40. In these figures, as the heating system is outside the holder, a first portion of the conduit extends through the holder, i.e. inside the holder, and a second portion extends outside the holder. A valve system may be at the conduit 13 to control the air flow towards the opening. In some examples, a plurality of conduits may connect the heater and the opening.

The heater 40 and the flow generator 30 of FIGS. 1a and 1b are outside the holder 10. In some examples, the heater may be inside the holder and the flow generator may be outside the holder. In some examples, both the heater and the flow generator may be inside the holder. In some examples, a heater and a flow generator may be in a single housing, e.g. when both the heater and the flow generator are inside or outside the holder.

In some examples, the flow generator may comprise a fan to generate an air flow. The fan may be electrically powered. The fan may comprise a plurality of blades which rotates to increase the speed of air flowing in between. The fan may for example generate a flow rate of air between 0.005 m³/s and 15 m³/s with a velocity of 1 m/s to 10 m/s. In some examples, the flow generator may comprise a plurality of fans. The air flow generator may be switchable to start and to stop generating the air flow.

In some examples, the flow generator may comprise a reservoir to contain pressurized air to generate an air flow, e.g. through an opening of the reservoir. A pump may be provided to generate or maintain a pressure inside a reservoir.

In FIGS. 1a and 1b, an air flow 31 generated by the air flow generator 30 passes through the heater 40 to generate a heated air flow 41. In some examples, a heater may heat air flowing towards the air flow generator to generate a heated air flow. In some examples, heated air may be maintained inside a reservoir and then ejected through an opening.

The heated air may heat the garment and the print agent previously deposited on it to a temperature at or above a sublimation temperature of the print agent. The sublimation temperature of the print agent may between 150° C. and 250° C.

The heater may comprise a heating element. In some examples, the heating element may be an electrical heating element which converts electrical energy into heat through a Joule heating process.

In some examples, the electrical heating element may comprise a resistive heating element having a material with an electric resistance with a positive temperature, i.e. with an electric resistance that decreases with increasing temperature. An example of a resistive heating element may be a heating wire made from metal.

In some examples, the electrical heating element may comprise a Positive Temperature Coefficient (PCT) ceramic. PCT ceramic materials exhibit a positive resistance in response to an increase in temperature. As the temperature increases, the electrical resistance of the PCT ceramic materials also increases and the current flow may thus be limited. Accordingly, a temperature of a PCT heating element may be self-regulated and self-limited and electronics for controlling the temperature of the heater may thus be avoided. Overheating of the heater may thus be avoided. In addition, the power consumption of PCT heating elements may drop when a predetermined temperature is reached. Accordingly, energy consumption of the sublimation device may be reduced.

In some examples, the PCT heating element may operate at an operation temperature of between 150° C. and 350° C., e.g. between 200° C. and 260° C. As the operation temperature of the PCT heating element may be maintained with low power consumption, the flow generator may be turned on for sublimating a previously deposited print agent and turned off when no garment is received by the holder. Accordingly, the flow generator may be selectively switchable to discontinuously generate an air flow and power consumption of the flow generator and of the heater may thus be reduced.

In some examples, the heating element may comprise a burner to burn gas to heat an air flow. In some examples, the heating element may be a tube through which a hot fluid may circulate.

In some examples, the heater may comprise a plurality of heating elements. The plurality of heating elements may be in a grid configuration or at perforated plate. In some examples, heating elements may be connected to fins or may be integrated to fins.

The heated air may pass through the opening of the holder at a sublimation temperature or above. In some examples, a sublimation temperature of the print agent may be between 170° C. and 220° C. In some examples, the print agent may be heated to a temperature at or above the sublimation temperature of the print agent. For example, ink may be heated to a temperature between 195° C. and 260° C. Ink may be sublimated in 2 to 10 seconds, e.g. between 3 to 5 seconds. Sublimating time, i.e. time for sublimating a print agent deposited on a garment, may be reduced. This may allow enhancing a quality of the image as more print agent may remain on the garment as less print agent is evaporated because the print agent is exposed to the heated air flow during less time.

The opening on the outer surface may have a size corresponding to a print zone of a garment to be received by the holder. For example, the opening may be greater than the print zone. In some examples, the opening on the outer surface of the holder may comprise a grid to prevent external elements from entering into the holder.

The holder may comprise an insulating material to prevent an excessive temperature on the outer surface of the holder.

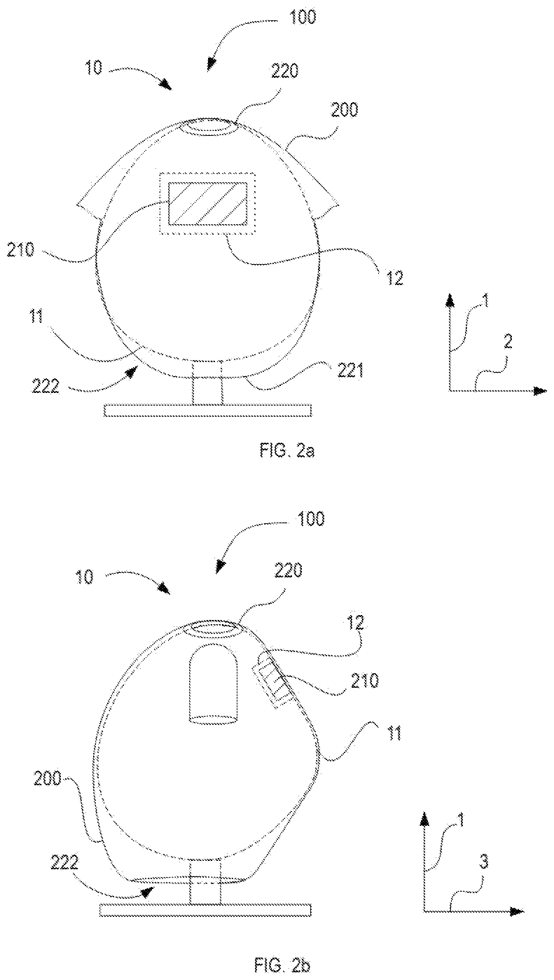

FIG. 2a and FIG. 2b respectively illustrates a holder 10 of the sublimation device of FIG. 1a and FIG. 1b holding a garment 200 in which an image has been printed. For clarity purposes the heating system of the sublimation device of FIG. 1a and FIG. 1b has not been illustrated and the portion of the holder covered by the garment has been illustrated with a dotted line.

In these examples, the garment 200 is a T-shirt having an inner side in contact with the outer surface 11 of the holder. In these figures, the garment 200 is received by holder by displacing the garment along the axis 1. In these figures, the garment is lowered along the axis 1 to match a print zone 210 of outer side of the garment with the opening 12 of the holder. In FIG. 2a-2b the garment is received from the upper portion of the holder and then is lowered such that the neckline 220 of the T-shirt is positioned on the upper portion of the holder and a waist 221 on a lower portion of the holder. The T-shirt of these examples may thus be displaced around the holder from top to bottom along the axis 1.

In other examples, a T-shirt may be received by the holder by displacing the T-shirt around the holder along the axis 2 or along the axis 3. This may depend on the shape of the holder.

In other examples, the garment may be for example a pair of trousers or a cap. A holder to receive a pair of trousers may comprise a pair of legs attached to a central portion. For placing a pair of trousers over the holder, the waistband of the trousers may be positioned around the legs of the holder and the trousers may then be displaced along the holder to fill the cavity formed between the waistband and the bottom of the trousers. The waistband of the trousers may be positioned around the central portion of the holder and the legs of the trousers around the legs of the holder. The pair of trousers may be moved around the holder along the axis 1 to be received by the holder. In other examples, the pair of trousers may be moved along the axis 2 or 3.

An inner cavity 222 formed by the inner side of the garment may be filled by the outer surface 11 of the holder 10. In these examples, the garment is stretched to the shape of the holder. Accordingly, wrinkles in the print zone 210 may be avoided.

A print zone of the garment is an area of the garment on which print agent is to be deposited to form an image. As the inner side of the garment contacts the outer side of the holder, the print zone is on the outer side of the garment.

The print zone 210 of these figures may be placed on the opening 12 of the holder. Heated air may thus be directed from inside holder to the print zone of the outer zone passing through the garment. Once the garment is received by the holder, the position of the garment may be adjusted to place the print zone over the opening. For example, the garment may be rotated around the axis 1 to make the print zone match with the opening. In some examples, the shape of the opening and the print zone may substantially match. In other examples, the opening may be greater than the print zone.

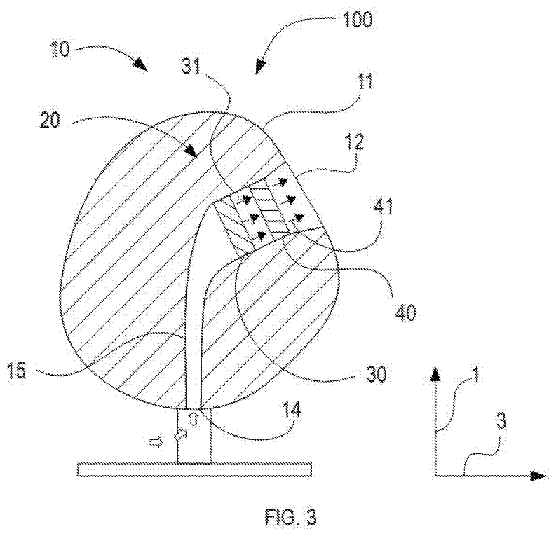

FIG. 3 illustrates a cross-sectional view of a sublimation device 100 according to one example of the present disclosure. In FIG. 3 the heating system 20 is inside the holder. In this example, the holder comprises an inlet 14 to enter air. The flow generator 20 may generate an air flow 31 from air entering through the inlet 14. An internal passage 15 may communicate the inlet and the flow generator 30. The air flow 31 may be heated by the heater 40 and the heated air 41 may flow through the opening 12. The heating system may thus be integrated in the holder. Accordingly, the sublimation device may be more compact and transportation of the sublimation device may be facilitated.

The heater 40 may be positioned close to the opening 12. Heat losses may thus be reduced. For example, the heater may be positioned at a distance of less than 10 centimeters with respect to the opening 12. In some examples, the heater 40 may be at a distance lower than 5 centimeters with respect to the opening 12.

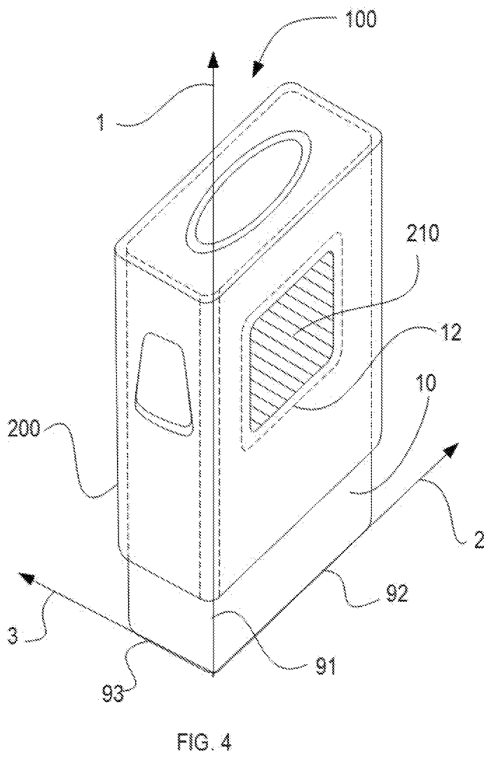

FIG. 4 schematically illustrates an example of a sublimation device 100 holding a garment 200 according to the present disclosure. In this figure, the portion of holder covered by the garment has been illustrated with a dotted line. In this example, the heating system 20 is inside the holder 10. The shape of the holder 10 of FIG. 4 is a cuboid. The T-shirt received by the holder may thus be stretched to enclose the holder 10.

The holder of this figure comprises a length 91 extending along a first axis 1, a width 92 extending along the second axis 2 and a depth 93 extending along the third axis 3. In this example, the holder 10 is to receive the garment 200 along the first axis 1 such that the garment 200 is displaced along the first axis 1 around the holder 10. The garment may thus partially enclose the holder.

In the example of FIG. 4 the print zone 210 extends on a plane defined by the axis 1 and 2. In other examples, the print zone may extend for example on a plane formed between the axis 1 and 3.

In FIG. 4, the depth 93 of the holder is higher than a 25% of the width 92 of the holder. The holder may thus occupy the inner space of the T-shirt. For example, the width 92 may be about 50 cm and the depth 93 may be about 15 cm. In some examples, the width 92 may be between 40 and 70 and the depth 93 may be between 10 cm and 25 cm.

In some examples, the depth 93 may be higher than a half of the width 92 of the holder. For example, the width 92 may be about 30 cm and the depth 93 may be 20 cm.

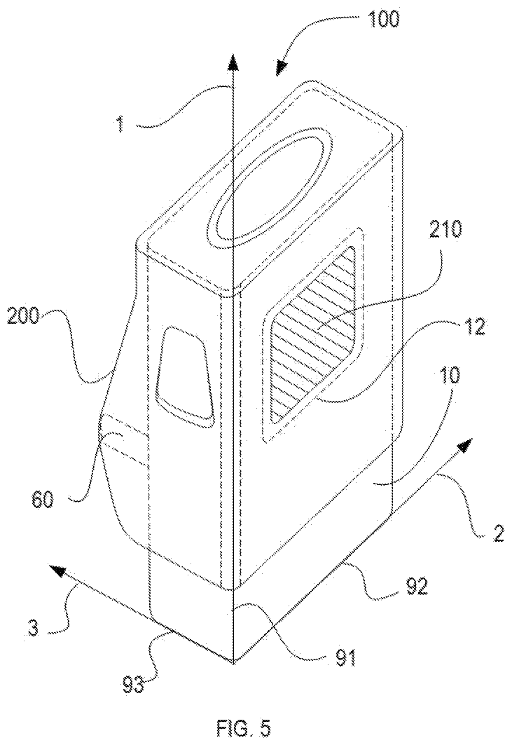

FIG. 5 schematically illustrates an example of a sublimation device 100 holding a garment 200 according to the present disclosure. In this figure, the portion of holder covered by the garment has been illustrated with a dotted line. In this example, the holder comprises a tensioner 60 to tense the garment 10. The tensioner 60 may be at the opposite side of the opening 12. The tensioner 60 may thus increase the pressure applied on the garment to reduce wrinkles on the print zone 210.

In this example, the tensioner protrudes from the outer surface of the garment to increase the tension provided by the holder to the garment. In some examples, a tensioner may be extensible to stretch different shapes or sizes of the garment. In some examples, a tensioner may be hingedly connected to the outer surface.

In some examples, the holder may expand or compress to adjust its shape to the inner cavity of the garment. In some examples, the holder may be expandable and may comprise a tensioner. Adaptability to different shapes or sizes may thus be increased.

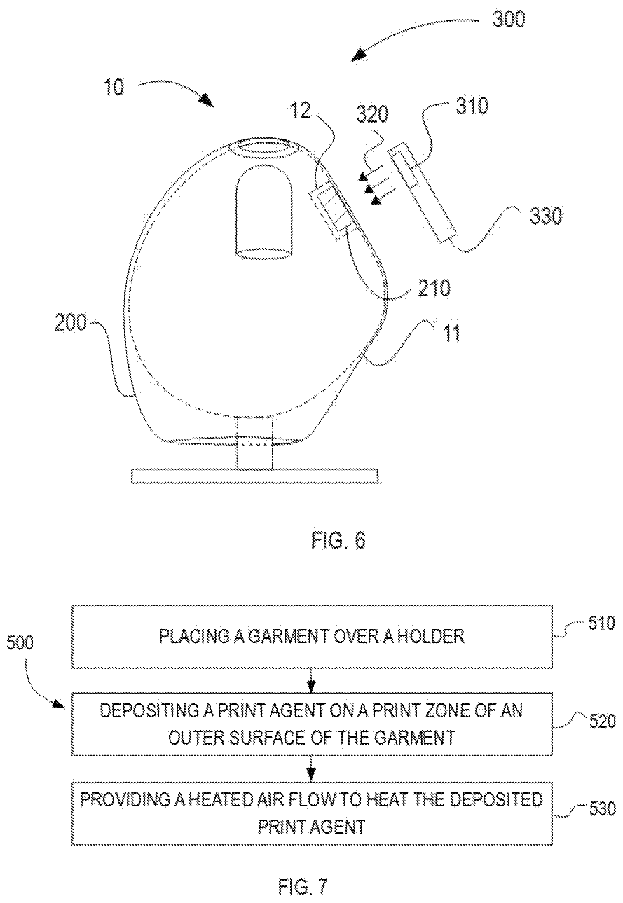

FIG. 6 schematically illustrates an example of a system 300 for direct to garment printing according to the present disclosure. The system 300 comprises a holder 10 to receive a garment 200, a heating system to heat an air flow (not shown in FIG. 6) and a print head 310 to deliver a print agent 320 onto a print zone 210 of an outer side of the garment 200 when the garment is received by the holder 10. The holder 10 comprises an outer surface 11 to contact an inner side of the garment opposite to the outer side of the garment 200 and an opening 12 on the outer surface 11 in fluid communication with the heated air flow.

In this disclosure direct to garment printing refers to printing an image on a garment by depositing a print agent with a print head directly on the garment. Transfer processes involving a sublimation transfer printable medium and a heat press are thus avoided in direct to garment printing.

The garment 200 may thus receive a print agent 320 delivered by the print head 310 onto the print zone 210 and this delivered print agent may be sublimated by applying a heated air flow on the print zone through the opening when the garment is placed enclosing the holder. Accordingly, printing and sublimating may be performed in a single sublimation device. Movements of the garments during printing and sublimating may be reduced and the productivity of sublimation printing (including printing and sublimating) an image on a garment may thus be increased.

The print head 310 may be moved towards the print zone 210 to directly apply a print agent on the garment. Using sublimation transfer printable medium and a heat press may thus be avoided. Consequently, press marks and ghosting defects may be reduced.

The system 300 for direct to garment printing may comprise the sublimation device according to any of the examples herein described. For example, the heating system may comprise a flow generator to generate an air flow and a heater to heat the air flow according to any of the examples herein disclosed.

In the example of FIG. 6, the print head 310 is mounted on a handheld printer 330. A handheld printer may be held by a hand of a user which may move the handheld printer in any direction or position. A user may freely move the handheld printer close to the print zone 210 of the garment. Accordingly, the handheld printer may be used for directly delivering a print agent onto different types of garments and to different sizes and positions of the print zones. The handheld printer may also increase the accessibility of some parts of the garment. For examples, an armpit area of a T-shirt may be printed by depositing a print agent with a handheld printer.

In some examples, the handheld printer may include a sensor. The sensor may detect for example a position, an inclination or a speed of the handheld printer. In some examples, the handheld printer may include a sensor or a plurality of sensors to determine a position, an inclination and a speed of the handheld printer. In these examples, the print agent may be delivered at predetermined position or distance with respect to the print zone.

The handheld printer may comprise a battery to power the handheld printer. The handheld printer may operate independently from an electrical grid.

In some other examples, the print head may be mounted on a supporting structure. The movable supporting structure may be associated with the holder. Print agent may be delivered when the print head is mounted on the supporting structure. In some examples, the supporting structure may be movable with respect to the holder and the print head may thus be moved to deliver print agent onto the print zone of the outer side of the garment.

The print head may be provided with a plurality of nozzles to deliver print agent, e.g. ink, onto the print zone so as to print an image on the outer side of the garment. In this disclosure, delivering includes firing, ejecting, spitting or otherwise depositing print agent or ink. The print head may comprise a print agent chamber containing print agent to be delivered onto the garment.

In some examples, the print head may comprise a heating element to cause a rapid vaporization of print agent in the print agent chamber, increasing an internal pressure inside this print agent chamber. This increase in pressure makes a drop of print agent exit from the print agent chamber to the print zone through a nozzle. A print head of this type may be called as thermal inkjet print head.

In some examples, a piezo electric may be used to force a drop of print agent to be delivered from a print agent chamber onto the print zone of the garment. A voltage may be applied to the piezo electric, which may change its shape. This change of shape may force a drop of print agent to exit through the nozzle. These print heads be called as piezo electric print heads.

The print agent, e.g. ink, may be heated to a temperature above the sublimation temperature to become gaseous. The sublimation temperature of the print agent may be between 150° C. and 250° C. In some examples, the sublimation temperature may be between 170° C. and 220° C. Air flow may be directed through the opening towards the previously deposited print agent at a temperature between 5° C. and 100° C. above the sublimation temperature of the print agent. In some examples, the print agent may be heated to a temperature between 175° C. and 320° C. In some examples, ink may be heated to a temperature between 195° C. and 260° C.

In some examples, the holder may comprise a guide to position the print zone of the outer surface over the opening. The guide may help the user to place the print zone in a position to receive the heated air through the opening. The guide may indicate the position of the opening to ensure that the print zone is placed on the opening for directing the heated air towards the print zone.

In some examples, a guide may be an indentation or a plurality of indentations on the outer surface of the holder. A user may detect the position of the indentation behind the garment covering the holder.

In some examples, a guide may be a visual mark. A visual mark may help a user to align the print zone of the garment with respect to the opening. The visual mark may be a light. A light may go through the garment. The print zone may thus be aligned after placing the garment on the holder.

FIG. 7 is a block diagram of an example of a method to print a garment according to the present disclosure. The method 500 comprises placing 510 a garment over a holder such that an inner side of the garment contacts the holder, depositing 520 a print agent on a print zone of an outer side of the garment opposite to the inner side of the garment, and providing 530 a heated air flow from an inside the holder to the inner side of the garment to heat the deposited print agent.

The method 500 to print a garment may use a sublimation device or a system for direct to garment printing according to any of the examples herein described.

The garment, e.g. a T-shirt, may be placed around the holder in such a way that outer surface of the holder contacts the inner side of the garment. The holder may fill an internal cavity defined by the inner side of the garment. The holder may provide pressure to the garment to stretch the garment to reduce wrinkles on a print zone on which print agent is to be deposited. The garment may be moved along one axis to enclose the holder with the garment.

A print agent may be deposited on a print zone of an outer side of the garment with the print head according to any of the examples herein described. The print agent may thus be directly applied onto the garment, avoiding using sublimation transfer printable media and heat presses. The print agent is deposited onto the print zone when the garment is held by the holder.

A heated air flow may be provided, e.g. guided towards the deposited print agent, to sublimate the deposited print agent. The heated air flow may heat the deposited print agent to a temperature at or above the sublimation temperature of the print agent. The print agent is delivered and sublimated while the garment is held by the holder. In an example, the heated air flow is applied to the garment in a direction opposite to the direction used to deposit the printing agent, i.e., a backflow of heated air is provided.

An opening on the holder may guide the heated air to the print zone of the outer side passing through the garment. The heated air may thus pass through the garment from the inner side to the outer side. The opening may be in fluid communication with the heated air flow.

In some examples, the method may comprise adjusting the position of the garment to place a print zone of the outer side of the garment over the opening. For example, the garment may be rotated to make coincide the opening with the print zone. For example, the garment may be placed surrounding the holder and then the garment may be adjusted to position the print zone over the opening to receive the heated air.

In some examples, the outer side of the garment may comprise a plurality of print zones. A first image may be printed in a first print zone and a second image may be printed in a second print zone. After printing and sublimating a first image, the position of the garment may be adjusted to place the second print zone over the opening. Then, a print agent may be deposited on the second print zone and heated air may be provided to sublimate this deposited print agent.

In some examples, the method to print a garment may comprise generating an air flow and heating the air flow to a temperature at or above a sublimation temperature of the print agent.

In some examples, the method may comprise heating the air flow to a temperature between 150° C. and 350° C. In some examples, the method may comprise heating the air flow to a temperature between 200° C. and 260° C.

In some examples, the print agent may be heated to a temperature between 175° C. and 320° C. In some examples, the print agent, e.g. ink, may be heated to a temperature between 195° C. and 260° C.

In some examples, the print agent deposited onto the print zone may be heated to a temperature at or above the sublimation temperature of the print agent during 2 to 10 seconds. In some examples, the print agent may be heated during 3 to 5 seconds. The print agent may be sublimated in a short time. This short time may permit less to print agent to be evaporated and thus more print agent may remain on the garment. Higher image quality may be achieved.

In some examples, the air flow may be heated by a Positive Temperature Coefficient (PCT) ceramic. A PCT heating element may be maintained at a temperature between 150° C. and 350° C. In some examples, the PCT heating element may be maintained at a temperature between 200° C. and 260° C. These temperatures may be maintained with low power consumption.

In some examples, the method may comprise heating the air flow with a PCT element and maintaining the operation temperature of the PCT at a temperature between 200° C. and 260° C. In these examples, the method may comprise activating an air flow generator to generate an air flow after depositing a print agent onto the print zone and deactivating the air flow generator to stop generating the air flow when the print agent is sublimated. For example, the air flow generator may generate the air flow during 2 to 10 seconds. Power consumption for generating an air flow may thus be reduced.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A sublimation device comprising:
a heating system comprising:
a flow generator to generate an air flow; and
a heater to heat the air flow;
a holder to receive a garment, the holder comprising:
an outer surface to contact an inner side of the garment opposite to an outer side of the garment in which a print agent is to be deposited; and
an opening on the outer surface in fluid communication with the heated air flow.

2. The sublimation device according to claim 1, wherein the heater is outside the holder.

3. The sublimation device according to claim 1, wherein the heater is inside the holder.

4. The sublimation device according to claim 3, wherein the flow generator is inside the holder.

5. The sublimation device according to claim 1, wherein the sublimation device comprises a conduit extending through the holder to communicate the opening with the heater.

6. The sublimation device according to claim 1, wherein the holder comprises a length extending along a first axis, a width extending along a second axis and a depth extending along a third axis; and wherein the holder is to receive the garment along the first axis such that the garment is displaced along the first axis around the holder.

7. The sublimation device according to claim 6, wherein the depth of the holder is higher than a 25% of the width of the holder.

8. The sublimation device according to claim 1, wherein the holder comprises a tensioner to tense the garment.

9. The sublimation device according to claim 1, wherein the holder is adjustable in shape.

10. A system for direct to garment printing comprising:
a heating system to heat an air flow;
a holder to receive a garment, the holder comprising:
an outer surface to contact an inner side of the garment opposite to an outer side of the garment; and
an opening on the outer surface in fluid communication with the heated air flow;
a print head to deliver a print agent onto a print zone of the outer side of the garment when the garment is received by the holder.

11. The system according to claim 10 wherein the holder comprises a guide to position the print zone over the opening.

12. The system according to claim 10, wherein the print head is mounted on a handheld printer.

13. A method to print a garment, comprising:
placing a garment over a holder such that an inner side of the garment contacts the holder;
depositing a print agent on a print zone of an outer side of the garment opposite to the inner side of the garment; and
providing a heated air flow from an inside the holder to the inner side of the garment to heat the deposited print agent.

14. The method according to claim 13, comprising:
generating an air flow; and
heating the air flow to a temperature at or above a sublimation temperature of the print agent.

15. The method according to claim 13, wherein the heated air flow is guided to the inner side of the garment through an opening on the holder; and wherein the method comprises adjusting the position of the garment to place the print zone of the outer side of the garment over the opening.
